(19) United States
(12) Patent Application Publication
(10) Pub. No.: US 2013/0129866 A1
(43) Pub. Date: May 23, 2013

(54) Caffeinated Creamer

(71) Applicants: Daniel Paul Phillips, Penhook, VA (US); Daniel Donovan Phillips, Midlothian, VA (US)

(72) Inventors: Daniel Paul Phillips, Penhook, VA (US); Daniel Donovan Phillips, Midlothian, VA (US)

(21) Appl. No.: 13/475,488

(22) Filed: May 18, 2012

Related U.S. Application Data
(60) Provisional application No. 61/548,921, filed on Oct. 19, 2011.

(51) Int. Cl. A23C 11/00

(52) U.S. Cl. CPC A23C 11/00
USPC 426/72; 426/580; 426/601; 426/609

(57) ABSTRACT

Additives for beverages may comprise caffeine, vitamins and/or other supplements. The additives may be for hot beverages such as coffee or tea. An additive for a beverage may consist essentially of a creamer and caffeine. The creamer may be a liquid creamer or a solid creamer. An additive may comprise a caffeine concentration from 2 milligram caffeine per milliliter of creamer to 15 milligrams caffeine per milliliter of creamer, for example.

The additive may be in a single serving container. The single serving container may comprise from 20 milligrams of caffeine to 200 milligrams of caffeine, for example. A powdered non-dairy creamer may also comprise caffeine. The additive may comprise a creamer and vitamins. The vitamins may be B-vitamins. The B-vitamins may be selected from the group consisting of Vitamin B2, Vitamin B3, Vitamin B5, Vitamin B6, Vitamin B12, and combinations thereof.

### RELATED APPLICATIONS

This patent application claims priority under 35 U.S.C. §119 to U.S. Provisional Patent Application No. 61/548,921 filed on Oct. 19, 2011 which is hereby incorporated by reference in its entirety.

### FIELD OF THE INVENTION

The invention is directed to beverage additives. Embodiments of the additive comprise a creamer and caffeine. Additional embodiments of the creamer comprise creamer and vitamins, stimulants, and/or other supplements. Still further embodiments of the additive comprise caffeine, electrolytes and vitamin and/or other supplements.

### BACKGROUND

Coffee and tea are some of the most consumed prepared beverages in the world. Both beverages include caffeine. Many people drink coffee in the morning to help them feel more fully wake up or in the evening to delay tiredness and remain alert. Many people flavor their coffees with milk, cream, non-dairy creamers, and other flavors including flavored creamers. The caffeine content of a cup of coffee varies depending on the brewing method, the variety of bean, as well as other factors. Some people enjoy strong, highly caffeinated coffee such as espresso, others enjoy a milder cup of coffee with a moderate amount of caffeine, and still others enjoy decaffeinated coffee. Though typically a person will drink the same type of coffee regularly, there are times when they may desire a coffee or other beverage with a higher concentration of caffeine at times though it may not be available. At other times, a person may only have a decaffeinated coffee available but would like to consume some caffeine to prevent tiredness, to increase their mood, for general alertness, studying or late night driving, for example.

Further, many people have coffee every morning. Some of these people may also take a vitamin, other supplement or medication also.

As such, there is a need for an additive for beverages that includes an amount of caffeine. The additive may be used to increase the concentration of caffeine in a caffeinated beverage or to add caffeine to a beverage that does not comprise caffeine. The additive may be added to a decaffeinated coffee, for instance.

There is a further need for a creamer for coffee or tea that comprises caffeine. The creamer may then be used to add flavor and increase the concentration of caffeine in the coffee or tea.

There is still a further need for a creamer that contains vitamins, other supplements, and/or medications. There is additional need for a beverage additive comprising caffeine, electrolytes, and vitamins or other supplements.

### SUMMARY

The invention is related to additives for beverages. The beverages may be hot beverages such as coffee or tea, cold beverages such as water, iced tea, milk, juices, and/or carbonated beverages such as soft drinks or alcoholic beverages. Embodiments of an additive for beverages consist essentially of a creamer and caffeine. Additional embodiments of the additive for beverages consist essentially of a creamer and an aqueous solution of caffeine. Embodiments of the additive may be added to coffee to increase the concentration of caffeine in the coffee. At different times, coffee drinker may want different amounts of caffeine in their coffee. For example, early in the morning, during late night studying or driving long distances, a person may desire coffee that comprises more caffeine than is naturally occurring in coffee. At other times when only decaffeinated coffee is available, a person may want to “re-caffeinate” the coffee to avoid caffeine withdrawals or to induce an increase in energy or attentiveness.

Further embodiments of an additive for beverages comprise a creamer and caffeine. In any embodiments, the creamer may be a liquid creamer or a solid creamer. In embodiments of the liquid creamer, the additive may comprise a caffeine concentration from 0.15 grams caffeine per milliliter of creamer to 1.5 grams caffeine per milliliter of creamer, for example. In further embodiments of the liquid creamer, the additive comprises a caffeine concentration from 0.15 grams caffeine per milliliter of creamer to 1.0 grams caffeine per milliliter of creamer, for example. In other embodiments, the additive may comprise a caffeine concentration from 2 milligrams caffeine per milliliter to 5 milligrams caffeine per milliliter. In more specific embodiments, the additive may comprise a caffeine concentration from 2.5 milligrams caffeine per milliliter to 3.5 milligrams caffeine per milliliter.

For embodiments of the additive in a single serving container, the additive may comprise from 20 milligrams of caffeine to 200 milligrams of caffeine, for example. In further embodiments of the single serving container, the additive may comprise from 40 milligrams of caffeine to 100 milligrams of caffeine, for example. In other embodiments of a single serving container, the additive may comprise from 20 milligrams of caffeine to 50 milligrams of caffeine.

Further embodiments of a single serving container of creamer may comprise from 5 mg. (0.5 mg./ml.) to 300 mg (30 mg./ml.) of caffeine, or from 30 (3 mg./ml.) to 150 mg (15 mg./ml.) of caffeine, or from 20 milligrams (2 mg./ml.) of caffeine to 200 milligrams (20 mg./ml.) of caffeine, or even from 40 milligrams (40 mg./ml.) of caffeine to 100 milligrams (10 mg./ml.) of caffeine.

For embodiments of a powdered non-dairy creamer, the additive may comprise a caffeine concentration from 0.005 grams caffeine per gram of powdered non-dairy creamer to 0.05 grams caffeine per gram of powdered non-dairy creamer, for example.

The additive may comprise a creamer and B-vitamins. The B-vitamins may be selected from the group consisting of Vitamin B2, Vitamin B3, Vitamin B5, Vitamin B6, Vitamin B12, and combinations thereof. Further embodiments of the additive may comprise a supplement. The supplement may be selected from at least one of methylxanthines, herbsacai, taurine, ginseng, ginkgo biloba, and combinations thereof, for example.

Embodiments of a powdered additive for coffee or tea may comprise a creamer and a stimulant. The stimulant may be a stimulant other than caffeine. Still further embodiments of the additive comprise a creamer and at least one of a vitamin, supplement, medication, or a combination thereof. The vitamins may be B-vitamins. Embodiments of the powdered additive may comprise at least one of methylxanthincs, herbsacai, taurine, ginseng, ginkgo biloba, and combinations thereof, for example.

In another embodiment of the invention, a sports additive for a beverage comprises electrolytes and caffeine. In another embodiment, the sports additive for a beverage consists essentially of electrolytes, vitamins and caffeine. The sports additive may be added to a beverage to provide additional electrolytes that may be lost during exercise and caffeine to boost alertness and performance. Embodiments of the sports additive may further comprise vitamins. Embodiments of the sports additive may be a liquid or solid additive.

Other aspects and features of embodiments of the method will become apparent to those of ordinary skill in the art, upon reviewing the following description of specific, exemplary embodiments of the present invention in concert with the figures. While features may be discussed relative to certain embodiments and figures, all embodiments can include one or more of the features discussed herein. While one or more particular embodiments may be discussed herein as having certain advantageous features, each of such features may also be integrated into various other of the embodiments of the invention (except to the extent that such integration is incompatible with other features thereof) discussed herein. In similar fashion, while exemplary embodiments may be discussed below as system or method embodiments it is to be understood that such exemplary embodiments can be implemented in various systems and methods.

### DESCRIPTION OF EMBODIMENTS

The invention is related to additives for beverages. The additive comprises caffeine and other ingredients. In one embodiment, the additive may be an additive for coffee, tea, carbonated beverages, or other beverage comprising creamer and caffeine. The additive provides a convenient means of adding or increasing the amount of caffeine in the beverage, if desired. Embodiments of the additives may comprise flavorings other than creamers, vitamins,

dietary supplements and/or preservatives without departing from the basic features. For example, embodiments of the additive may comprise B-vitamins. B-Vitamins may be components of energy drinks because they provide essential nutrition. The B vitamins are common in dietary supplements have been reported to support and increase the rate of metabolism, maintain healthy skin, hair and muscle tone, enhance immune and nervous system function, promote cell growth and division, including that of the red blood cells that help prevent anemia, to improve the symptoms of attention deficit hyperactivity disorder, and reduce the risk of pancreatic cancer, for example. However, the B-vitamins are water-soluble and must be consumed regularly to maintain the proper amounts in the body. Other embodiments of the additive for coffee, tea, carbonated beverages, or other beverages consist essentially of creamer and caffeine. The additive for beverages may further comprise electrolytes. The electrolytes may be in a concentration range from 20 milligrams to 200 milligrams of electrolytes for a single serving size additive.

Any vitamin may be included in an embodiment of the additive. Both water soluble and fat soluble vitamins may be included. B-vitamins commonly found in dietary supplements and energy drinks are Vitamin B2 (riboflavin), Vitamin B3 (niacin), Vitamin B5 (pantothenic acid), Vitamin B6, Vitamin B12, and combinations thereof. Additional vitamins and supplements that may be included in embodiments of the additive include, but are not limited to, Vitamin C, Vitamin D, methylxanthines, herbsacai, taurine, ginseng, ginkgo biloba, and combinations thereof, for example.

Vitamins are available from many sources. For example, individual vitamin powders are available from SIGMA-ALDRICH®. Also, combinations of vitamins are available in both liquid and solid forms such as from http://www.5150juice.com. For example, a B-vitamin supplement is available comprising 1.7 mg of riboflavin (Vitamin B12) as riboflavin 5′-phosphate sodium, 20 mg. of niacin as niacinamide, 2 mg. of Vitamin B6 as pyridoxine hydrochloride, 1.2 mg. of Vitamin B12 as cyanocobalamin, and 30 mg. of pantothenic acid as dexpanthenol. The combinations of vitamins may include additional ingredients such as water, sweeteners, preservatives, flavorings and other desired ingredients. Other combinations of vitamins or other concentrations of vitamins may be used and the flavorings other than creamers, vitamins, dietary supplements and/or preservatives may be added in a combination, individually, or both.

As used herein, “creamer” means a dairy or nondairy product sold or packaged for use as an additive, typically, for coffee or tea. Creamers include, but are not limited to, milk, cream, heavy cream, a blend of cream and milk such as half and half, nondairy creamers in liquid or powdered forms and so called “whiteners.” Non-dairy creamers often contain vegetable-based fats and are typically classified as “non-dairy” products because they do not include lactose, though non-dairy creamer may comprise components of creamers such as, but not limited to, sodium caseinate, a milk protein. Other common ingredients of non-dairy creamers include corn syrup or other sweeteners and flavorings. A typical non-dairy creamer may consist of water, sugar, palm oil, corn syrup, sodium caseinate, dipotassium phosphate, natural and artificial flavors, mono and diglycerides, sodium stearoyl lactylate, carrageenan, and/or salt, for example. Other non-dairy creamers may comprise all or some of these components. For example, vegans may prefer a creamer that does not include sodium caseinate derived from milk or other dairy products.

In the embodiments, the additive for a beverage may comprise creamer, caffeine, vitamins, and flavorings. Creamers are available commercially through many sources.

Caffeine is a bitter, white crystalline xanthine alkaloid and psychoactive stimulant that is soluble in water. Caffeine is found in varying quantities in the seeds, leaves, and fruit of some plants. It is most commonly consumed by humans in infusions extracted from the bean of the coffee plant and the leaves of the tea bush. Other sources include yerba mate, guarana berries, guayusa, and the yaupon holly.

Caffeine acts as a central nervous system stimulant, temporarily warding off drowsiness and increasing alertness. Common sources of caffeine are coffee, tea, and (to a lesser extent) chocolate derived from cocoa beans. Caffeine is also a common ingredient of carbonated beverages or soft drinks, such as colas, originally prepared from kola nuts. Soft drinks typically contain about 10 to 50 milligrams of caffeine per serving. By contrast, energy drinks, such as RED BULL™, can start at 80 milligrams of caffeine per serving. The approximate caffeine content of select beverages is below.

TABLE 1
Caffeine Concentration of Various Common Beverages

| | | | Caffeine per |
|---|---|---|---|
| Product | Serving size | | serving (mg) |
| Caffeine tablet | 1 tablet | | 100 |
| (regular-strength) | | | |
| Caffeine tablet | 1 tablet | | 200 |
| (extra-strength) | | | |
| Excedrin tablet | 1 tablet | | 65 |
| Hershey's Special Dark | 1 bar | (43 g; 1.5 oz) | 31 |
| Hershey's Milk Chocolate | 1 bar | (43 g; 1.5 oz) | 10 |
| Percolated coffee | 207 mL | (7 U.S. fl oz) | 80-135 |
| Drip coffee | 207 mL | (7 U.S. fl oz) | 115-175 |
| Coffee, decaffeinated | 207 mL | (7 U.S. fl oz) | 5-15 |
| Coffee, espresso | 44-60 mL | (1.5-2 U.S. fl oz) | 100 |
| Black tea | 177 mL | (6 U.S. fl oz) | 50 |
| Guayakí yerba | 6 g | (0.2 U.S. oz) | 85 |
| mate (loose leaf) | | | |
| COCA-COLA | 355 mL | (12 U.S. fl oz) | 34 |
| CLASSIC ™ | | | |
| MOUNTAIN DEW ™ | 355 mL | (12 U.S. fl oz) | 54 |
| MONSTER ™ energy | 500 mL | (16.4 U.S. fl oz) | 160 |
| drink | | | |
| RED BULL ™ | 250 mL | (8.2 U.S. fl oz) | 80 |

The caffeine in these drinks either originates from the ingredients used or is an additive derived from the product of decaffeination of a naturally caffeinated product or from chemical synthesis of caffeine. Guarana, a prime ingredient of energy drinks, contains large amounts of caffeine with small amounts of theobromine and theophylline in a naturally occurring slow-release excipient.

Various manufacturers market caffeine tablets, claiming that using caffeine of pharmaceutical quality improves mental alertness. These effects have been borne out by research that shows caffeine use (whether in tablet form or not) results in decreased fatigue and increased attentiveness. These tablets are commonly used by students studying for their exams and by people who work or drive for long hours.

The precise amount of caffeine necessary to produce effects varies from person to person depending on body size and degree of tolerance to effects of caffeine. It normally takes less than an hour for caffeine to begin affecting the body. An oral dose of 200 mg caffeine appears to decrease reaction time by approximately 4 percent within 30 minutes, approximately 15 percent in 30 to 60 minutes and 18 percent in 60-90 minutes. A mild dose wears off in three to four hours. Consumption of caffeine, though taken to stay awake, does not eliminate the need for sleep but only temporarily reduces the sensation of being tired. Caffeine also leads to fewer mistakes caused by tiredness in shift workers.

Caffeine is available commercially in both liquid and solid form. Caffeine is available as an anhydrous solid powder such as from http://www.bulkcaffeinepowder.com/. Caffeine dissolved in water is also available dissolved in water such as from www.5150juice.com. Caffeine dissolved in water is available in various concentrations such as 16,000 mg. of caffeine dissolved in 32 ounces of water (16.9 mg./ml), for example.

Embodiments of the creamer may comprise any desired amount of caffeine. Though chocolate does contain some caffeine, the amount of caffeine present in embodiments of the invention exceeds that in a chocolate flavored creamer that may comprise a minimal amount of caffeine. In some embodiments, the additive may be a liquid creamer or a solid or powdered creamer. In liquid embodiments, embodiments of the additive may comprise a caffeine concentration from 0.1 grams caffeine per milliliter of creamer to 1.5 grams caffeine per milliliter of creamer; in other embodiments, the additive may comprise a caffeine concentration from 0.15 grams caffeine per milliliter of creamer to 1.0 grams caffeine per milliliter of creamer. In embodiments of the liquid creamer, the additive may comprise a caffeine concentration from 0.15 grams caffeine per milliliter of creamer to 1.5 grams caffeine per milliliter of creamer, for example. In further embodiments of the liquid creamer, the additive comprises a caffeine concentration from 0.15 grams caffeine per milliliter of creamer to 1.0 grams caffeine per milliliter of creamer, for example. In other embodiments, the additive may comprise a caffeine concentration from 2 milligrams caffeine per milliliter to 5 milligrams caffeine per milliliter. In more specific embodiments, the additive may comprise a caffeine concentration from 2.5 milligrams caffeine per milliliter to 3.5 milligrams caffeine per milliliter.

For embodiments of the additive in a single serving container, the additive may comprise from 20 milligrams of caffeine to 200 milligrams of caffeine, for example. In further embodiments of the single serving container, the additive may comprise from 40 milligrams of caffeine to 100 milligrams of caffeine, for example. In other embodiments of a single serving container, the additive may comprise from 20 milligrams of caffeine to 50 milligrams of caffeine.

Further embodiments of a single serving container of creamer may comprise from 5 mg. (0.5 mg./ml.) to 300 mg (30 mg./ml.) of caffeine, or from 30 (3 mg./ml.) to 150 mg (15 mg./ml.) of caffeine, or from 20 milligrams (2 mg./ml.) of caffeine to 200 milligrams (20 mg./ml.) of caffeine, or even from 40 milligrams (40 mg./ml.) of caffeine to 100 milligrams (10 mg./ml.) of caffeine.

For embodiments of a powdered non-dairy creamer, the additive may comprise a caffeine concentration from 0.005 grams caffeine per gram of powdered non-dairy creamer to 0.05 grams caffeine per gram of powdered non-dairy creamer, for example.

Creamers, either liquid or powdered, are sold in various sizes from single serving sizes to gallon sizes or more. Embodiments of the creamers comprising caffeine may be packaged and sold in any container size. At restaurants, coffee shops, convenience stores, and gas stations, creamers are available in single serving containers. A single serving container holds between 0.3 ounces (8.9 ml.) and 0.5 ounces (14.8) of creamer and a user may add one or more single serving container to a beverage. For example, a single serving container of creamer may be 10 ml. The amount of creamer added to a beverage is a personal preference considering the size of the beverage, the tastes of the user and the flavorings in the creamer, for example. In a typical sixteen ounce cup of coffee, a person may add between 0 and 8 single serving containers of creamer, for example. The creamers may all be caffeinated creamers or may be a combination of caffeinated creamers and conventional creamers. The stimulants, vitamins, supplements, and other components for liquid creamers may only be incorporated up to their solubility limits. For example, caffeine has a solubility in water of 2.17 g/100 mL at 25° C.

Therefore, embodiments of a single serving container of creamer may comprise from 5 mg. (0.5 mg./ml.) to 300 mg (30 mg./ml.) of caffeine, or from 30 (3 mg./ml.) to 150 mg (15 mg./ml.) of caffeine, or from 20 milligrams (2 mg./ml.) of caffeine to 200 milligrams (20 mg./ml.) of caffeine, or even from 40 milligrams (40 mg./ml.) of caffeine to 100 milligrams (10 mg./ml.) of caffeine.

In embodiments of a powdered creamer, the additive may comprises a caffeine concentration from 0.005 grams caffeine per gram of powdered non-dairy creamer to 0.05 grams caffeine per gram of powdered non-dairy creamer. The creamers may also comprise additional components such as, but not limited to, vitamins, health supplements and additional stimulants, for example. The vitamins may include B-Vitamins, Vitamin C or Vitamin D, for example. The B-Vitamins that are commonly included in energy drinks include Vitamin B2 (Riboflavin), Vitamin B3 (Niacin), Vitamin B5 (Panothenic acid), Vitamin B6, Vitamin B12, and combinations thereof. The most common B-vitamins in energy drinks are Vitamin B3 (Niacin), Vitamin B6 and Vitamin B12. The additional stimulants or supplements may be methylxanthines, herbsacai, taurine, ginseng, and ginkgo biloba, for example. Liquid creamers are available in a variety of container sizes.

The additive for beverages may also comprise at least one flavor additive. The flavor additive may be natural or artificial and may be any desired flavoring. A flavoring is a component that is added primarily to add a specific taste to the additive. Many components will have some taste associated with them but may be added for other purposes. Therefore, as used herein, stimulants and vitamins may not be considered to be flavorings. Many flavorings are available such as from Flavour Art at http://www.flavourartexpress.biz/ or Capella Flavors, Inc. at http://capellaflavordrops.com/, for example.

Embodiments of the sports additive comprise caffeine and electrolytes. Embodiments of the sports additive may further comprise flavoring, vitamins, dietary supplements and/or preservatives without departing from the basic features. The sports additive may be added to any beverage including, but not limited to, water, carbonated waters, fortified waters, carbonated beverages, soft drinks, coffee, hot or cold tea, fruit juices, or other beverage, for example.

In physiology, the primary ions of electrolytes are sodium (Na+), potassium (K+), calcium (Ca2+), magnesium (Mg2+), chloride (Cl−), hydrogen phosphate (HPO42−), and hydrogen carbonate (HCO3−). These electrolytes are ionic in nature from chemical dissociation in solution. Sodium is the main electrolyte found in extracellular fluid and is involved in fluid balance and blood pressure control.

Animals require a subtle and complex electrolyte balance between the intracellular and extracellular environment. Such balance affects and regulates the hydration of the body as well as blood pH, and may be critical for proper nerve and muscle function. Both muscle tissue and neurons are considered electric tissues of the body and are activated by electrolyte activity between the extracellular fluid and intracellular fluid. For example, muscle contraction is dependent upon the presence of calcium (Ca2+), sodium (Na+), and potassium (K+). Without sufficient levels of these key electrolytes, muscle weakness or severe muscle contractions may occur.

Electrolyte balance is typically maintained by oral, or in emergencies, intravenous (IV) intake of electrolyte-containing substances and the balance is regulated by hormones, generally with the kidneys flushing out excess levels. Serious electrolyte disturbances, such as dehydration and overhydration, may lead to cardiac and neurological complications and, unless they are rapidly resolved, may result in a medical emergency.

To rehydrate, electrolyte drinks containing sodium and potassium salts replenish the body's water and electrolyte levels to prevent and treat dehydration caused by exercise, excessive alcohol consumption, diaphoresis, diarrhea, vomiting, intoxication or starvation. Athletes exercising in extreme conditions who do not consume electrolytes risk dehydration.

An embodiment of the sports additive may comprise sugar, salt, salt substitute for potassium, and/or baking soda. Water may be the best beverage for simply rehydrating the body, but during exercise or just being outside on a hot day electrolytes are also lost through perspiration. The resulting lowered concentration of electrolytes in the body may adversely affect the function of the central nervous system.

Many sports drinks reduce the risk of water intoxication by replenishing fluids and electrolytes in a ratio similar to that normally found in the human body. A sports drink beverage is designed to help athletes rehydrate when fluids are depleted after training or competition. Electrolyte replacement promotes proper rehydration, which is important in delaying the onset of fatigue during exercise. As the primary fuel utilized by exercising muscle, carbohydrates are important in maintaining exercise and sport performance.

Conventional sports drinks may comprise excessive amounts of sugar and do not comprise caffeine. A typical sports drink may comprise water, high fructose corn syrup, salt, potassium citrate, phenylalanine, sucralose, sodium citrate, malic acid, potassium phosphate, Vitamin B6, and Vitamin B2. Embodiments of the sports additive may comprise any of these components and caffeine.

### EXAMPLES

### Example 1

### Hazelnut Beverage Additive

10 ml. single serving size additives for a beverage were prepared by combining cream, an aqueous solution of caffeine, vitamins, and flavorings. 2 ml. of an aqueous solution (5150 Energy Sweet(tm)) comprising water, 16 mg./ml. caffeine, natural sweetener, and sodium benzoate (preservative) was combined with 0.5 ml. vitamin solution (Liquid B Vitamin from www.5150juice.com) comprising 0.7 mg of riboflavin (Vitamin B12) as riboflavin 5′-phosphate sodium, 20 mg. of niacin as niacinamide, 2 mg. of Vitamin B6 as pyridoxine hydrochloride, 1.2 mg. of Vitamin B12 as cyanocobalamin, and 30 mg. of pantothenic acid (Vitamin B5) as dexpanthenol, 6 ml. of creamer (COFFEEMATE™ unflavored creamer), and 1.5 ml of hazel nut flavoring (CAPELLA™ ). The mixture was then blended to provide an additive for a beverage.

### Example 2

Two single 10 ml. single serving size additives were added to a 16 ounce coffee to increase the caffeine concentration of the beverage.

The embodiments of the described products and methods are not limited to the particular embodiments, components, method steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. An additive for coffee or tea, consisting essentially of:
a creamer; and
caffeine.

2. The additive of claim 1, further comprising B-vitamins.

3. The additive of claim 2, wherein the B-vitamins are selected from the group consisting of Vitamin B2, Vitamin B3, Vitamin B5, Vitamin B6, Vitamin B12, and combinations thereof.

4. The additive of claim 1, further comprising at least one of methylxanthines, herbsacai, taurine, ginseng, ginkgo biloba, and combinations thereof.

5. The additive of claim 1, wherein the additive is a liquid creamer and the additive comprises a caffeine concentration from 1 milligrams caffeine per milliliter of creamer to 150 milligrams caffeine per milliliter of creamer.

6. The additive of claim 5, wherein the additive is a liquid creamer and the additive comprises a caffeine concentration from 2 milligram caffeine per milliliter of creamer to 15 milligrams caffeine per milliliter of creamer.

7. The additive of claim 1, wherein the additive is in a single serving container and the additive comprises from 10 milligrams of caffeine to 200 milligrams of caffeine.

8. The additive of claim 7, wherein the additive is in a single serving container and the additive comprises from 20 milligrams of caffeine to 100 milligrams of caffeine.

9. The additive of claim 1, wherein the additive is a powdered non -dairy creamer and the additive comprises a caffeine concentration from 0.005 grams caffeine per gram of powdered non-dairy creamer to 0.05 grams caffeine per gram of powdered non-dairy creamer.

10. A powdered additive for coffee or tea, comprising:
a non-dairy creamer; and
a stimulant.

11. The powdered additive of claim 10, further composing vitamins.

12. The powdered additive of claim 11, wherein the vitamins are B vitamins.

13. The powdered additive of claim 121, wherein the B-vitamins comprise Vitamin B2, Vitamin B3, Vitamin B5, Vitamin B6, Vitamin B12, or combinations thereof.

14. The powdered additive of claim 13, further comprising at least one of methylxanthines, herbsacai, taurine, ginseng, ginkgo biloba, and combinations thereof.

15. The powdered additive of claim 10, wherein the stimulant is caffeine.

16. A additive for coffee or tea, comprising:
a creamer; and
caffeine;
at least one of a vitamin or a supplement.

17. The powdered additive of claim 16, wherein the vitamin is Vitamin C.

18. The powdered additive of claim 16, wherein the vitamin comprises B-vitamins.

19. The powdered additive of claim 18, wherein the B-vitamins comprise one of Vitamin B2, Vitamin B3, Vitamin B5, Vitamin B6, Vitamin B12, or combinations thereof.

20. The powered additive of claim 16, wherein the supplements comprise at least one of methylxanthines, herbsacai, taurine, ginkgo biloba, and combinations thereof.
